(19) United States
(12) Patent Application Publication
(10) Pub. No.: US 2005/0112272 A1
(43) Pub. Date: May 26, 2005

(54) Bulking agents for baked goods

(76) Inventors: Chai-Yen Kao, Singapore (SG); Boon Keng Leow, Singapore (SG)

Correspondence Address: NATIONAL STARCH AND CHEMICAL COMPANY, P.O. BOX 6500, BRIDGEWATER, NJ, 08807-3300, US

(21) Appl. No.: 10/951,182

(22) Filed: Sep. 27, 2004

Related U.S. Application Data
(60) Provisional application No. 60/506,528, filed on Sep. 26, 2003.

(51) Int. Cl. A23G 3/30

(52) U.S. Cl. 426/658

(57) ABSTRACT

The present invention is directed towards a blend for use as a bulking agent in baked goods. The bulking agent of the present invention comprises a starch hydrolysis product, a bulk sweetener, and an emulsifying agent. The bulking agent serves as a direct, one-to-one, replacement of sugar in the baked product without the need for reformulation of other ingredients and/or process modifications.

### BACKGROUND OF THE INVENTION

1. Technical Field. The present invention relates to bulking agents for use in baked products. More specifically, the present invention is directed towards a hydrocolloid system for use as a bulking agent in baked goods as a direct replacement of sugar.

2. Background Information

In baked products such as cakes, cookies, and muffins, and in fried products including doughnuts, sugar can constitute between 20% and 30% of the total ingredients. In richer formulations, such as in shelf-stable cakes or fruit cakes, the amount of sugar used can be as high as 35% to 38%. Both artificial and natural high intensity sweeteners are commonly added to reduced sugar and sugar-free baked products to impart sweetness in place of the sugar. However, the amount required of these sweeteners is typically very low, e.g., in a range of about 0.05% to about 0.10% of the total ingredients. As such, the substitution of sugar, a major component in such products, with one or more high intensity sweeteners leaves a void in the product formulation. This loss in weight and volume is typically filled with bulking agents.

Bulking agents are well known ingredients used to replace sugar in reduced sugar or sugar free baked goods. With their addition, these agents at least partially compensate to some degree for the nonsweetening effects of sugar in a food product.

When used in replacing the loss in weight and volume in reduced sugar and sugar-free products, bulking agents which possess several of sugar's key physical properties, including:
i) a high degree of solubility;
ii) low and stable viscosity when heat processed;
iii) an ability to develop color (via Maillard reaction) at baking temperatures; and
iv) being somewhat hygroscopic (i.e., a natural preservative in the cake) are desired.

Without bulking agents, sugar-free or reduced sugar products such as cake batter will have excessively thick and viscous consistency when whisked. As the expansion and airiness of the cake when baked is related to a certain extent to the quantity of air cells incorporated at mixing, a sugar-free cake lacking a bulking agent can be expected to have poor volume and dense texture.

There are various types of bulking agents used in the preparation of reduced sugar or sugar-free baked products. These include resistant starches, dextrins, and maltodextrins.

While each of the above-identified bulking agents may serve other functions in addition to their role as a filler or replacement for sugar, e.g., sweetening or fiber, none of them serve as an adequate replacement for sugar. There still is a need for a bulking agent that provides all of these benefits and improves the texture of the baked products in which it is used. Additionally, there is a need for an improved bulking agent or bulking agent blend that provides in a reduced sugar or sugar-free baked product a one-to-one replacement for the weight and volume lost in the removal of the sugar from the formulation. Further, there is a need for a bulking agent blend that improves the viscosity of the formulation, dough or batter of the baked product.

### SUMMARY OF THE INVENTION

The present invention is directed towards a blend for use as a bulking agent in baked goods. The bulking agent of the present invention comprises a starch hydrolysis product, a bulk sweetener, and an emulsifying agent.

The bulking agent serves as a direct, one-to-one, replacement of sugar in the baked product without the need for reformulation of other ingredients and/or process modifications. In particular, the bulking agent is very useful in the preparation of a sugar-free sponge cake.

The bulking agent of the present invention is suitable for use in sugar-free or reduced sugar baked goods. These foods include foods suitable for diabetics, as well as food for slimming purposes. The bulking agent of the present invention can be used in formulating reduced calorie baked goods in that it may be formulated to a caloric content of less than 2.4 kcal/g. Additionally, the bulking agent of the present invention permits high fiber labeling of foods prepared with it.

Bulking agent, as used herein, is intended to mean an ingredient or combination of ingredients which can be used in conjunction with a high intensity sweetener to replace sugar.

Baked good or baked product, as used herein, is intended to include baked products and fried products which conventionally contain a high percentage (at least 10%) sugar, and is intended to include without limitation cakes, cookies, muffins, and donuts.

Reduced sugar baked good, as used herein, is intended to mean one which contains less sugar than conventional, and in one embodiment is intended to mean a baked good containing less than about 10% sugar by weight.

Hydrolysis, as used herein, is the chemical reaction of a molecule with water to produce two or more smaller molecules. Specific hydrolysis products can be formed by acid, alkali, or enzyme catalysis, or a combination thereof, depending upon the type of product sought. Hydrolysis products is intended to include, without limitation, dextrins and maltodextrins, which are at least partially indigestible or resistant to digestion.

Bulk sweetener, as used herein, is intended to include sugar alcohols, or polyols, including without limitation sorbitol, mannitol and xylitol.

Dextrins are starch hydrolysis products obtained in a dry roasting process (pyrolysis) either using starch alone or with trace levels of acid catalyst. The products are characterized by good solubility in water giving stable viscosities. Four types exist: white, yellow, British gums and solution-stable dextrins. White dextrin is generally used for food and medicines. White dextrins typically contain up to about 5% of an indigestible component. Conventional yellow dextrins, which can contain up to about 30% of an indigestible component, can have a strong taste. British gums are usually dark yellow or brown, and darker in color than standard yellow dextrins. They are prepared by the dry roasting of neutral pH starch at high temperatures.

Indigestible dextrins can be produced by pyrolysis and subsequent enzymatic treatment similar to the process for manufacturing conventional maltodextrins, wherein the enzymatic treatment converts at least a portion of the α-1,4 glucose linkages. Indigestible dextrins can also be produced by a process similar to that for producing dextrins, wherein a starch is acid catalyzed and heat treated under high pressure. This process converts up to 50% of the 1→4 glycosidic linkages and results in a dextrin which contains at least 60% of an indigestible component. Indigestible dextrins serve as a source of dietary fiber.

Maltodextrins are starch hydrolysis products having a degree of hydrolysis or dextrose equivalent (“DE”) of less than 20. They are conventionally produced by the action of an amylase enzyme on gelatinized starch. This enzymatic treatment can be performed so as to remove or breakdown (“convert”) at least a portion of the α-1,4 glucose linkages. Maltodextrin contains a range of non-sweet polysaccharides with a distribution of molecular weights where the anhydroglucose units are linked predominantly by 1,4 bonds. Indigestible maltodexttrins are known in the art, including ActiStar RM commercially sold by Cerestar, Fibersol resistant maltodextrins commercially sold by Matsutani and those described in European Patent No. 0 846 704, U.S. Pat. No. 5,358,729, U.S. Pat. No. 5,364,652, U.S. Pat. No. 5,430,141, U.S. Pat. No. 5,472,732, and U.S. Pat. No. 5,620,873.

As used herein, dextrose equivalent (DE) is defined as the reducing power of the hydrolyzate. Each starch molecule has one reducing end: therefore DE is inversely related to molecular weight. The DE of anhydrous D-glucose is defined as 100 and the DE of unhydrolyzed starch is virtually zero.

Resistant maltodextrins and dextrins (maltodextrins and dextrins resistant to digestion) are those which are not digestible by the human body in that they or their degradation products are not absorbed in the small intestine of healthy individuals.”

Resistant starches are those food starches or starch derivatives which are not digestible by the human body. The official definition of resistant starches is “the sum of starch and products of starch degradation not absorbed in the small intestine of healthy individuals.”

There are four main groups of resistant starches currently available: RS₁, RS₂ RS₃ and RS₄. RS₁, is physically inaccessible starch, e.g., trapped in seeds. For RS₁, to be digested, the seed or outer coating must be broken so that the starch granules are no longer entrapped. RS₂ is granular starch, is ungelatinized, and cannot be digested by amylases until gelatinized. Examples include banana, uncooked potatoes, peas and high amylose starches. RS₃ is a highly retrograded, non-granular starch, and is found in extruded or ready-to-eat cereals, bread, and cooked and cooled potatoes. RS₄ is a starch which is chemically modified. These groups of resistant starches all have different properties, but in general have positive effects on food texture, processing and colonic health. Although starches, resistant starches generally analyze as total dietary fiber using the AOAC method.

Water fluidity (WF), as used herein, is an empirical test of viscosity measured on a scale of 0-90 wherein fluidity is the reciprocal of viscosity. Water fluidity of starches is typically measured using a Thomas Rotational Shear-type Viscometer (commercially available from Arthur A. Thomas CO., Philadelphia, Pa.), standardized at 30° C. with a standard oil having a viscosity of 24.73 cps, which oil requires 23.12±0.05 sec for 100 revolutions. Accurate and reproducible measurements of water fluidity are obtained by determining the time which elapses for 100 revolutions at different solids levels depending on the starch's degree of conversion: as conversion increases, the viscosity decreases.

Gelatinization or starch conversion is the irreversible swelling of starch granules under the influence of heat and/or chemicals in an aqueous medium to give a starch paste. During the swelling process amylose tends to leach from the starch granules and the amylopectin becomes fully hydrated. Viscosity rises and is at a peak when the granules are hydrated to their maximum extent and are in close contact with their neighbors. If heating continues, the granules then rupture, collapse and fragment. Gelatinized starches are intended to include those which no longer exhibit a full Maltese cross and birefringence under polarized light. Pregelatinized starch is intended to mean that which has been gelatinized prior to use in a baked good.

### DETAILED DESCRIPTION OF THE INVENTION

The present invention is directed towards a blend for use as a bulking agent in baked goods. The bulking agent of the present invention comprises a starch hydrolysis product, a bulk sweetener, and an emulsifying agent.

Starch, as used herein, is intended to include all starches and flours derived from tubers, grain, legumes and seeds or any other native source, any of which may be suitable for use herein. A native starch as used herein, is one as it is found in nature. Also suitable are starches derived from a plant obtained by standard breeding techniques including crossbreeding, translocation, inversion, transformation or any other method of gene or chromosome engineering to include variations thereof which are typically referred to as genetically modifies organisms (GMO). In addition, starch derived from a plant grown from artificial mutations and variations of the above generic composition, which may be produced by known standard methods of mutation breeding, are also suitable herein.

Typical sources for the starches are cereals, tubers, roots, legumes and fruits. The native source can be corn (maize), pea, potato, sweet potato, banana, barley, wheat, rice, oat, sago, amaranth, tapioca (cassaya), arrowroot, canna, and sorghum, as well as waxy or high amylase varieties thereof. As used herein, the term “waxy” or “low amylose” is intended to include a starch containing no more than about 10%, particularly no more than about 5%, most particularly no more than about 2%, by weight amylose. As used herein, the term “high amylose” is intended to include a starch containing at least about 40%, particularly at least about 70%, most particularly at least about 80%, by weight amylose. The invention embodied within relates to all starches regardless of amylose content and is intended to include all starch sources, including those which occur in nature, are genetically altered, or are obtained from hybrid breeding.

The bulking agent of the present invention includes at least one starch hydrolysis product produced from a starch using methods known in the art, including without limitation by acid, alkali, or enzyme catalysis, or a combination thereof, depending upon the type of product sought. Hydrolysis products is intended to include, without limitation, dextrins and maltodextrins, which are at least partially indigestible or resistant to digestion. Dextrins is intended to include at least partially indigestible or resistant white, yellow, British gums and solution-stable dextrins.

Maltodextrins are intended to include those with a dextrose equivalent (“DE”) of less than 20 which are at least partially indigestible or resistant to digestion and is intended to include maltodexttrins such as ActiStar RM commercially sold by Cerestar, Fibersol resistant maltodextrins commercially sold by Matsutani and those described in European Patent No. 0 846 704, U.S. Pat. No. 5,358,729, U.S. Pat. No. 5,364,652, U.S. Pat. No. 5,430,141, U.S. Pat. No. 5,472,732, and U.S. Pat. No. 5,620,873.

The bulking agent further contains at least one bulk sweetener. In one embodiment, the bulk sweetener is a sugar alcohols or polyols. In another embodiment, the bulking agent is selected from the group consisting of sorbitol, mannitol and xylitol.

Sorbitol is produced industrially by the catalytic hydrogenation of D-glucose that has been obtained by enzymatic hydrolysis of starch. Unlike reducing sugars, sorbitol does not undergo browning reactions with amines and amino acids. Its relative sweetness compared to sucrose is between 50 and 60. It is stable to mild alkaline and acidic conditions and will not react with other ingredients in the usual food, pharmaceutical and cosmetic formulations.

Mannitol is an isomer of sorbitol. While not quite as sweet as sugar, mannitol contributes only about half the calories of sugar and is poorly absorbed by the body. Mannitol has a desirable cooling effect which may be used to mask bitter tastes. Whereas sorbitol is a humectant, mannitol is nonhygroscopic and may therefore be used as a dusting powder.

Xylitol, a natural, non-fermentable carbohydrate, is as sweet as sugar while contributing only about one third of the calories.

The bulking agent further contains at least one emulsifying agent. In one embodiment the emulsifying agent is selected from the group consisting of a protein, a gum or a modified starch. In another embodiment, the emulsifying agent is a modified starch derivatized by treatment with any reagent or combination of reagents which contributes emulsification properties to the starch. In a third embodiment the starch is derivatized with a reagent which contains a hydrophobic moiety and may contain a hydrophilic moiety. In an additional embodiment, the hydrophobic moiety is an alkyl or alkenyl group which contains at least five carbon atoms, or an aralkyl or aralkenyl group which contains at least six carbon atoms, and in a further embodiment contains up to about twenty-four carbon atoms. The hydrophilic moiety may be contributed by the reagent or the starch's own hydroxyl groups may serve as the hydrophilic moiety and the reagent may contribute only the hydrophobic moiety. In one aspect of the invention, the emulsifying agent is an octenyl succinic anhydride (OSA) modified starch Any process for derivatizing (modifying) starch which yields the desired blend of hydrophobic or hydrophobic and hydrophilic functions on the starch molecule and thereby yields emulsification properties may be used to prepare the modified starch of the present invention. Suitable derivatives and methods for producing them are known in the art and disclosed for example in U.S. Pat. No. 4,626,288 which is incorporated herein by reference. In one aspect of the invention, the starch is derivatized by reaction with an alkenyl cyclic dicarboxylic acid anhydride by the method disclosed in U.S. Pat. Nos. 2,613,206 and 2,661,349, incorporated herein by reference, or alkylene oxide such as ethylene oxide or propylene oxide; in a further embodiment by reaction with octenylsuccinic anhydride.

Where a low viscosity is desirable, a useful embodiment is an octenyl succinic half ester derivative of an amylopectin containing starch, such as waxy maize, which has been converted to a water fluidity (WF) of up to about 60. In one embodiment, the converted starch is treated with from about 0.1% to about 3.0% of octenyl succinic anhydride. In the alternative, a hydroxypropyl octenyl succinic derivative may be used.

The modified starch emulsifying agent may be one that has been hydrolyzed or converted. The starch may be converted to its fluidity or thin-boiling form using a suitable method of degradation. Such degradation includes, for example, mild acid hydrolysis with an acid such as sulfuric or hydrochloric acid, conversion with hydrogen peroxide, or enzyme conversion. Converted starch products may include blends of different starches converted by various techniques as well as converted starch(es) blended with unconverted starch(es).

In preparing starches converted by acid treatment, the granular starch base is conventionally hydrolyzed to the desired viscosity in the presence of an acid, typically at a temperature below the gelatinization point of the starch. The starch is slurried in water, followed by addition of the acid, which is usually in concentrated form. Typically, the reaction takes place over an 8 to 16 hour period, after which the slurry pH may be adjusted to a pH of about 5.5. The starch may be recovered by filtration.

In converting starch by enzyme treatment, the starch base is conventionally slurried in water and pH adjusted to a range in which the specific enzyme efficiently works, generally from about 5.6 to about 5.7. A small amount of an enzyme such as α-amylase (e.g., about 0.02% on the starch) is added to the slurry. The slurry is typically heated above the gelatinization point of the starch, though some enzymes may function on granular starch. When the desired conversion is reached, the enzyme is deactivated, such as by pH adjustment with acid or by heat. Thereafter the pH may be adjusted. The type and concentration of the enzyme, the conversion conditions, and the length of conversion contribute to the composition of the resultant product. Other enzymes or combination of enzymes can be used.

Hydrogen peroxide can also be used to convert or thin the starch, either alone or with metal catalysts. The converted starch can be jet-cooked to ensure complete solubilization of the starch and deactivation of residual enzyme, if any.

The bulking agent may optionally contain at least one resistant starch. Resistant starches are well known in the art and include without limitation those of the RS₁, RS₂ RS₃ and RS₄ types, including NOVELOSE® and HI-MAIZE® starches commercially available from National Starch and Chemical Company.

Any starch or starch blends having suitable properties for use herein may be purified, either before or after any modification or conversion, by any method known in the art to remove starch off flavors, odors, or colors that are native to the starch or created during processing. Suitable purification processes for treating starches are disclosed in the family of patents represented by European Patent No. 554 818. Alkali washing techniques are also useful and described in the family of patents represented by U.S. Pat. Nos. 4,477,480 and 5,187,272.

The starch may be pregelatinized, making it cold-water dispersible. Various techniques known in the art, including drum drying, spray drying, or jet cooking can pregelatinize these starches. Exemplary processes for preparing pregelatinized starches are disclosed in U.S. Pat. Nos. 1,516,512; 1,901,109; 2,314,459; 2,582,198; 2,805,966; 2,919,214; 2,940,876; 3,086,890; 3,133,836; 3,137,592; 3,234,046; 3,607,394; 3,630,775; 4,280,851; 4,465,702; 5,037,929; 5,131,953, and 5,149,799.

The starch product may be pulverized to a powder. Alternatively, the product may be reduced to flake form, depending on the particular end-use, although the powdered form is preferred. Any conventional equipment such as a Fitz mill or hammer mill may be used to effect suitable flaking or pulverizing.

In one embodiment, the bulking agent comprises a resistant maltodextrin, sorbitol and octenyl succinic anhydride modified starch. In another embodiment, the bulking agent comprises a resistant maltodextrin, sorbitol and octenyl succinic anhydride modified starch in a ratio of 4:4:1.

The resulting bulking agent may be used in a baked product to replace sugar and in one embodiment may be used to replace sugar one-to-one. The bulking agent is typically used in an amount of at least about 10% by weight of the baked product, and in one embodiment is used in an amount of from 20 to 40% by weight of the baked product. The baked product may be any that uses sugar, including without limitation, cakes, cookies, muffins and donuts. In one embodiment, the baked product will additionally contain a high intensity sweetener and in one aspect of the invention, the high intensity sweetener will be in an amount of from about 0.05% to about 0.0% by weight of the baked product. The high intensity sweetener may be any known in the art and in one embodiment will be selected from the group consisting of saccharine and aspartame.

In the examples which follow, all parts and percentages are given by weight and all temperatures in degrees Centigrade (° C.) unless otherwise indicated. The following examples are presented to further illustrate and explain the present invention and should not be taken as limiting in any regard. All percents used are on a weight/weight basis.

### Experimental

A. Preparation of Dry Mixes for Baked Products Using Various Bulking Agent Blends

Nine different sponge cakes were prepared, each having a different sugar substituted bulking agent blend (“BA”) for comparison against a control sponge cake prepared with sugar. The blends tested were as follows—

| | |
|---|---|
| BA 1: | Sugar substituted with 100% resistant maltodextrin |
| BA 2: | Sugar substituted with resistant 50% maltodextrin and 50% |
| | sorbitol |
| BA 3: | Sugar substituted with 25% resistant maltodextrin and 75% |
| | sorbitol |
| BA 4: | Sugar substituted with resistant maltodextrin, sorbitol and |
| | octenyl succinate anhydride modified (“OSA”) starch |
| BA 5: | Sugar substituted with resistant maltodextrin, maltodextrin |
| | having a DE of 10-13, and OSA starch |
| BA 6: | Sugar substituted with resistant maltodextrin, maltodextrin |
| | having a DE of 13-16 and OSA starch |
| BA 7: | Sugar substituted with resistant maltodextrin, a cook-up |
| | hydroxy propyl starch and OSA starch |
| BA 8: | Sugar substituted with resistant maltodextrin, resistant |
| | starch, sorbitol and OSA starch |
| BA 9: | Sugar substituted with resistant maltodextrin, resistant |
| | starch, and OSA starch |
| CONTROL: | Sponge cake control formulation (i.e., cake prepared with |
| | sugar) |

TABLE 1
Dry Mix Test Formulation

| Trial # | Control | | BA1 | | BA2 | | BA3 | | BA4 | |
|---|---|---|---|---|---|---|---|---|---|---|
| Ingredients | gram | % | gram | % | gram | % | gram | % | gram | % |
| Cake Flour | 132 | 44 | 132 | 44 | 132 | 44 | 132 | 44 | 108.1 | 42.7 |
| Sugar | 132 | 44 | 0 | 0 | 0 | 0 | 0 | 0 | 0.0 | 0.0 |
| Crosslinked, | 9 | 3 | 9 | 3 | 9 | 3 | 9 | 3 | 0.0 | 0.0 |
| stabilized, pre- | | | | | | | | | | |
| gelled tapioca | | | | | | | | | | |
| OSA modified | 0 | 0 | 0 | 0 | 0 | 0 | 0 | 0 | 14.8 | 5.8 |
| starch | | | | | | | | | | |
| Resistant | 0 | 0 | 132 | 44 | 66 | 22 | 33 | 11 | 54.0 | 21.4 |
| maltodextrin | | | | | | | | | | |
| (Fibersol) | | | | | | | | | | |
| Sorbitol | 0 | 0 | 0 | 0 | 66 | 22 | 99 | 33 | 54.0 | 21.4 |
| Maltodextrin (DE | 0 | 0 | 0 | 0 | 0 | 0 | 0 | 0 | 0.0 | 0.0 |
| 10-13) | | | | | | | | | | |
| PO Modified | 0 | 0 | 0 | 0 | 0 | 0 | 0 | 0 | 0.0 | 0.0 |
| Tapioca Starch | | | | | | | | | | |
| Maltodextrin (DE | 0 | 0 | 0 | 0 | 0 | 0 | 0 | 0 | 0.0 | 0.0 |
| 13-16) | | | | | | | | | | |
| Resistant Starch | 0 | 0 | 0 | 0 | 0 | 0 | 0 | 0 | 0.0 | 0.0 |
| (containing 60% | | | | | | | | | | |
| fiber) | | | | | | | | | | |
| Skimmed Milk | 6 | 2 | 6 | 2 | 6 | 2 | 6 | 2 | 4.9 | 1.9 |
| Powder | | | | | | | | | | |
| Salt | 2.4 | 0.8 | 2.4 | 0.8 | 2.4 | 0.8 | 2.4 | 0.8 | 2.0 | 0.8 |
| Baking Powder | 4.5 | 1.5 | 4.5 | 1.5 | 4.5 | 1.5 | 4.5 | 1.5 | 3.7 | 1.5 |
| Emulsifier | 14.1 | 4.7 | 14.1 | 4.7 | 14.1 | 4.7 | 14.1 | 4.7 | 11.5 | 4.6 |
| Total | 300 | 100 | 300 | 100 | 300 | 100 | 300 | 100 | 253.0 | 100.0 |
| Trial # | BA5 | | BA6 | | BA7 | | BA8 | | BA9 | |
| Ingredients | gram | % | gram | % | gram | % | gram | % | gram | % |
| Cake Flour | 108.1 | 42.7 | 108.1 | 42.7 | 108.1 | 42.7 | 108.1 | 42.7 | 108.1 | 42.7 |
| Sugar | 0.0 | 0.0 | 0.0 | 0.0 | 0.0 | 0.0 | 0.0 | 0.0 | 0.0 | 0.0 |
| Crosslinked, | 0.0 | 0.0 | 0.0 | 0.0 | 0.0 | 0.0 | 0.0 | 0.0 | 14.8 | 5.8 |
| stabilized, pre- | | | | | | | | | | |
| gelled tapioca | | | | | | | | | | |
| OSA modified | 14.8 | 5.8 | 14.8 | 5.8 | 14.8 | 5.8 | 14.8 | 5.8 | 36.0 | 14.2 |
| starch | | | | | | | | | | |
| Resistant | 54.0 | 21.4 | 54.0 | 21.4 | 54.0 | 21.4 | 36.0 | 14.2 | 51.8 | 20.5 |
| maltodextrin | | | | | | | | | | |
| (Fibersol) | | | | | | | | | | |
| Sorbitol | 0.0 | 0.0 | 0.0 | 0.0 | 0.0 | 0.0 | 36.0 | 14.2 | 0.0 | 0.0 |
| Maltodextrin (DE | 54.0 | 21.4 | 0.0 | 0.0 | 0.0 | 0.0 | 0.0 | 0.0 | 0.0 | 0.0 |
| 10-13) | | | | | | | | | | |
| PO Modified | 0.0 | 0.0 | 0.0 | 0.0 | 54.0 | 21.4 | 0.0 | 0.0 | 0.0 | 0.0 |
| Tapioca Starch | | | | | | | | | | |
| Maltodextrin (DE | 0.0 | 0.0 | 54.0 | 21.4 | 0.0 | 0.0 | 0.0 | 0.0 | 0.0 | 0.0 |
| 13-16) | | | | | | | | | | |
| Resistant Starch | 0.0 | 0.0 | 0.0 | 0.0 | 0.0 | 0.0 | 36.0 | 14.2 | 20.2 | 8.0 |
| (containing 60% | | | | | | | | | | |
| fiber) | | | | | | | | | | |
| Skimmed Milk | 4.9 | 1.9 | 4.9 | 1.9 | 4.9 | 1.9 | 4.9 | 1.9 | 4.9 | 1.9 |
| Powder | | | | | | | | | | |
| Salt | 2.0 | 0.8 | 2.0 | 0.8 | 2.0 | 0.8 | 2.0 | 0.8 | 2.0 | 0.8 |
| Baking Powder | 3.7 | 1.5 | 3.7 | 1.5 | 3.7 | 1.5 | 3.7 | 1.5 | 3.7 | 1.5 |
| Emulsifier | 11.5 | 4.6 | 11.5 | 4.6 | 11.5 | 4.6 | 11.5 | 4.6 | 11.5 | 4.6 |
| Total | 253.0 | 100.0 | 253.0 | 100.0 | 253.0 | 100.0 | 253.0 | 100.0 | 253.0 | 100.0 |

B. Cake Preparation

All ten cakes (control plus nine BA blends) were prepared as follows. The ten separate dry mixes identified in Table 1 above were prepared and set aside, with each mix totaling 252.5 grams (50.5% of total cake weight). For each cake, two whole eggs (154.0 grams, 30.8% of total cake weight) were mixed together with water (65.0 grams, 13.0% of total cake weight) at medium speed for thirty (30) seconds. The dry mix was gradually folded in at low speed to the water/egg mixture. With the dry mix in, the batter was mixed at high speed for 3.5 minutes, or until the batter is lightly aerated (with the batter at a target specific gravity of between about 0.40 and about 0.50). The speed is then turned to low and vegetable oil added in (28.5 grams, 5.7% of total cake weight). The batter was poured into a round baking tray and baked in a preheated oven at 180° C. (355° F.) for thirty (30) minutes.

The specific gravity of each wet mix was as follows—

| | |
|---|---|
| BA 1 | 0.48 |
| BA 2 | 0.46 |
| BA 3 | 0.44 |
| BA 4 | 0.41 |
| BA 5 | 0.51 |
| BA 6 | 0.41 |
| BA 7 | 0.48 |
| BA 8 | 0.45 |
| BA 9 | 0.42 |
| CONTROL | 0.48 |

C. Results—Cake Batter Characteristics

The results of the physical characteristics of the nine cake batters versus the desired CONTROL cake batter is provided in Table 2 below—

TABLE 2
Cake Batter Physical Characteristics

| Trial # | Characteristics |
|---|---|
| BA 1 | White in color, thick, & fluffier. More viscous & not as |
| | pourable as CONTROL |
| BA 2 | Creamy white in color, pourable. Appeared more viscous |
| | than CONTROL |
| BA 3 | Creamy white in color, fluffy, pourable but slightly thick |
| BA 4 | Creamy white in color, pourable, close to CONTROL |
| BA 5 | Pale yellow in color, runny. Mixture appeared grainy. |
| | Unable to obtain targeted specific gravity |
| BA 6 | Mixture appeared grainy |
| BA 7 | Mixture appeared grainy and thick |
| BA 8 | Creamy white in color, thick and dense |
| BA 9 | Creamy white in color |
| CONTROL | Creamy white in color, fluffy, pourable |

D. Results—Baked Cake Internal and External Characteristics

The results of the physical characteristics of the nine baked cake versus the desired CONTROL baked cake is provided in Table 3 below—

TABLE 3
Baked Cake Physical Characteristics

| | Cake | | | | | | Overall |
|---|---|---|---|---|---|---|---|
| | Volume | | | | | | Rating |
| | (1 = Least, | Cake | Crumb | | Grain | Cake | (1 = Poor, |
| Trial # | 9 = Most) | Color | Color | Crust Quality | Quality | Texture | 9 = Excellent) |
| BA 1 | 7 | Pale, dark | Dull, dark | Thin with | Coarse | Very | 3 |
| | | brown | yellow | some large air | and | gummy | |
| | | | | pockets, dry | uneven air | | |
| | | | | and flaky | cells | | |
| BA 2 | 7.5 | Dark | Dull, dark | Thin and | Coarse | Gummy | 4 |
| | | brown | yellow | smooth with | and | | |
| | | | | some large air | uneven air | | |
| | | | | pockets | cells | | |
| BA 3 | 8 | Golden | Dull, dark | Thin and | Slightly | Slightly | 4 |
| | | brown | yellow | smooth with | coarse | gummy | |
| | | | | few air | and | | |
| | | | | pockets | uneven air | | |
| | | | | | cells | | |
| BA 4 | 8 | Golden | Bright | Thin and | Fine | Slow melt, | 8 |
| | | brown | yellow | smooth, | grains and | minimal | |
| | | | | minimal air | even air | gumminess | |
| | | | | pockets on | cells - | | |
| | | | | cake surface - | typical | | |
| | | | | typical | | | |
| BA 5 | 5 | Golden | Pale | Thin and | Coarse | Gummy | 6 |
| | | brown | yellow | smooth with | and | | |
| | | | | few air | crumbly | | |
| | | | | pockets | | | |
| BA 6 | 6 | Golden | Pale | Thin and | Coarse | Gummy | 6 |
| | | brown | yellow | smooth with | and | | |
| | | | | few air | crumbly | | |
| | | | | pockets | | | |
| BA 7 | 6 | Pale, | Pale | Thick, dry and | Coarse | Dry and | 3 |
| | | whitish | yellow | hard crust | and | firm | |
| | | yellow | | with cracked | crumbly | | |
| | | | | lines on | | | |
| | | | | surface | | | |
| BA 8 | 6 | Pale, | Pale | Slightly thick | Coarse, | Crumbly | 5 |
| | | whitish | yellow | with cracked | not | and grainy | |
| | | yellow | | lines | crumbly | | |
| BA 9 | 6 | Brown | Slightly | Slightly thin | Slightly | Slightly | 6 |
| | | | pale | with small air | coarse, | gummy, | |
| | | | yellow | pockets | less | very | |
| | | | | | crumbly | crumbly | |
| CONTROL | 9 | Golden | Bright | Thin and | Fine | Slowest | 9 |
| | | brown | yellow | smooth | grains and | melt, least | |
| | | | | without air | even air | grainy | |
| | | | | pockets on | cells | | |
| | | | | cake surface | | | |

E. Sugar-Free Sponge Cake

A sugar-free sponge cake was prepared with the following list of ingredients—

| Ingredient | Weight Percent |
|---|---|
| Cake Flour | 22.0 |
| BA 4 | 24.5 |
| Acesulphame K (artificial sweetener) | 0.05 |
| Whole eggs | 30.8 |
| Non-fat dry milk | 0.9 |
| Baking powder | 0.76 |
| Emulsifier (Admul Emulsponge) | 2.3 |
| Water | 13.0 |
| Corn oil | 5.7 |
| Vanilla flavor | (as desired) |
| Total percentage | 100.00% |

The sugar-free sponge cake formulation developed met the labeling requirement of “reduced sugar” and “sugar-free” as specified in Title 21, Rule 101.60(c) of the United States Food and Drug Administration [21 CFR § 101.60(c)]. The processing conditions and procedures were the same as those listed above in Experimental section B. Incorporation of BA 4 to the sponge cake formulation was at a 1 to 1 replacement basis—no reformulation of other ingredients was required. Color development on the crust during baking was natural. The end cake had good symmetry. Expansion was satisfactory. Crumb color was bright yellow, comparable to the CONTROL. Texture of the crumb was tender. The overall cell structures of the crumb were fine and uniform in size. Grains were just slightly coarser than those found in the CONTROL. The cake crumb tasted slightly gummy and less resilient to bite when compared to the control. However, it's overall rating was satisfactory and higher than cakes prepared from other bulking agents such as dextrins, maltodextrin, resistant maltodextrin, modified starches or resistant starch when used by themselves or in combination with each other (without the additional emulsifying agent as exemplified in BA 4).

As seen from the above results, the best bulking agent blend was BA 4. Sugar free sponge cakes made with this preferred bulking agent blend provided a consistent batter, i.e., one that was creamy, low in viscosity and white in color, close to that of the CONTROL. When baked this sugar free sponge cake exhibited characteristics most similar to that of the CONTROL. Externally, the cake provided even expansion and a golden brown crust similar to that of the control. Internally, the cake baked with the preferred bulking agent provided a bright yellowish crumb color, cells that were slightly coarser than the control, and a tender texture.

In contrast, sponge cakes made with the other bulking agents had a thick and significantly more viscous (less pourable) batter. When baked, these cakes exhibited a pale crust color, cracked lines on the cake surface, uneven expansion, poorer volume, dull and darker crumb color, bigger air cells, and a gummier texture.

F. Cookies

Model Cookie Formulation (Control)

| Ingredients | Baker's % |
|---|---|
| Low protein wheat flour | 100 |
| Margarine | 27 |
| Butter | 24 |
| Powdered sugar | 16 |
| Corn syrup (75Brix) | 4 |
| Non-Fat Dry Milk | 2 |
| Salt | 1 |
| Egg Yolk | 7 |
| Soy Protein | 2 |
| Modified tapioca starch¹ | 6 |

¹Modified tapioca starch H-50, commercially available from National Starch and Chemical Company

Sugar-Substituted Cookie Formulation

| Ingredients | Baker's % |
|---|---|
| Low protein wheat flour | 100 |
| Margarine | 27 |
| Butter | 24 |
| BA 4 | 20 |
| Acesulfame K | 0.095 |
| Non-Fat Dry Milk | 2 |
| Salt | 1 |
| Egg Yolk | 7 |
| Soy Protein | 2 |
| Water | 10 |
| Modified tapioca starch¹ | 6 |

¹Modified tapioca starch H-50, commercially available from National Starch and Chemical Company

Preparation Procedures
1. Powdered sugar or BA 4, NFDM, wheat flour, soy protein isolate and H-50 were weighed.
2. Margarine and butter were weighed separately.
3. Corn syrup with salt and egg yolk were mixed.
4. Dry mix was blended with margarine and butter using low speed until a sandy texture was achieved.
5. Liquid portion was blended in using low speed until a solid mass is formed.
6. Sheeted dough was cut into rectangular blocks with measurement of 2 cm by 6.5 cm, docked with 10 holes.
7. Cookies were placed on a baking mat and baked for 30 mins.

Results

Extension of baking time (5-10 minutes max) was preferred in the sugar-substituted formulation to enable moisture content of the end cookie reached an optimal level. Other than baking time, there was no change to the rest of the dough preparation procedures.

The dough of the sugar-substituted formulation was just slightly firmer than the control and approximately 10% water was added (based on baker's percentage) at mixing stage to achieve good machinability at dough forming stage.

The amount of spread in the sugar-substituted cookie during baking was not significantly different from that of the control. The colour of the sugar-substituted cookie was even but slightly browner than the control cookie. Colour development during baking was overall satisfactory. Symmetry of the cookie was as good as the control. The sugar-substituted cookie has shorter bite, faster melt in the mouth and was more tender in texture than the control cookie. No distinctive difference in flavor and aroma was noted between the sugar-substituted cookie and the control cookie.

Sugars (powdered & liquid) in a model cookie formulation are successfully replaced with FIBERTEX BA (bulking agent composition) to yield sugar-free cookies. Minimal change to the preparation procedures is required. Acesulfame K, a high intensity sweetener is added to impart sweetness.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

1. A functional bulking agent for use in baked goods, the bulking agent comprising:
at least one starch hydrolysis product which is indigestible or resistant to digestion;
at least one bulk sweetener; and
at least one emulsifying agent.

2. The bulking agent of claim 1, further comprising at least one resistant starch.

3. The bulking agent of claim 1, wherein the at least one emulsifying agent is a modified starch.

4. The bulking agent of claim 3, wherein the modified starch is an alkenyl succinic anhydride modified starch and/or an alkylene oxide modified starch.

5. The bulking agent of claim 4, wherein the modified starch is an octenyl succinic anhydride modified starch.

6. The bulking agent of claim 3, wherein the starch is pregelatinized.

7. The bulking agent of claim 3, wherein the starch is from a tapioca base.

8. The bulking agent of claim 3, wherein the starch is further converted.

9. The bulking agent of claim 1 wherein the at least one starch hydrolysis product is a maltodextrin.

10. The bulking agent of claim 9, wherein the maltodextrin is a resistant maltodextrin.

11. The bulking agent of claim 1, wherein the bulk sweetener is a sugar alcohol.

12. The bulking agent of claim 11, wherein the sugar alcohol is selected from the group consisting of sorbitol, mannitol, and xylitol.

13. The bulking agent of claim 11, wherein the sugar alcohol is sorbitol.

14. A functional bulking agent for use in baked goods, the bulking agent comprising:
at least one a resistant maltodextrin.,
at least one sorbitol, and
at least one octenyl succinic anhydride modified starch.

15. The bulking agent of claim 14, wherein the maltodextrin:sorbitol:starch ratio is 4:4:1.

16. A baked good comprising
at least one starch hydrolysis product which is indigestible or resistant to digestion;
at least one bulk sweetener; and
at least one emulsifying agent,
wherein the baked good is a reduced sugar or sugar-free baked good.

17. The baked good of claim 16, further comprising at least one resistant starch.

18. The baked good of claim 16, wherein the at least one emulsifying agent is a modified starch.

19. The baked good of claim 18, wherein the modified starch is an alkenyl succinic anhydride modified starch and/or an alkylene oxide modified starch.

20. The baked good of claim 19, wherein the modified starch is an octenyl succinic anhydride modified starch.

21. The baked good of claim 18, wherein the starch is pregelatinized.

22. The baked good of claim 18, wherein the starch is from a tapioca base.

23. The baked good of claim 18, wherein the starch is further converted.

24. The baked good of claim 16 wherein the at least one starch hydrolysis product is a maltodextrin.

25. The baked good of claim 24, wherein the maltodextrin is a resistant maltodextrin.

26. The baked good of claim 16, wherein the bulk sweetener is a sugar alcohol.

27. The baked good of claim 26, wherein the sugar alcohol is selected from the group consisting of sorbitol, mannitol, and xylitol.

28. The baked good of claim 26, wherein the sugar alcohol is sorbitol.

29. A baked good comprising
at least one a resistant maltodextrin.,
at least one sorbitol, and
at least one octenyl succinic anhydride modified starch,
wherein the baked good is a reduced sugar or sugar-free baked good.

30. The baked good of claim 29, wherein the maltodextrin:sorbitol:starch ratio is 4:4:1.

31. The baked good of claim 16, further comprising at least one high intensity sweetener.

32. The baked good of claim 29, further comprising at least one high intensity sweetener.

33. A method of reducing or eliminating the sugar in a baked good comprising substituting the bulking agent of claim 1 for the sugar.

34. A method of reducing or eliminating the sugar in a baked good comprising substituting the bulking agent of claim 14 for the sugar.

35. A method of reducing or eliminating the sugar in a baked good comprising substituting the bulking agent of claim 1 and a high intensity sweetener for the sugar.

36. A method of reducing or eliminating the sugar in a baked good comprising substituting the bulking agent of claim 14 and a high intensity sweetener for the sugar.
